(19) United States
(12) Patent Application Publication
(10) Pub. No.: US 2016/0266878 A1
(43) Pub. Date: Sep. 15, 2016

(54) AUTOMATIC WIREFRAMING USING IMAGES

(71) Applicant: CA, INC., New York, NY (US)

(72) Inventor: Serguei Mankovskii, San Ramon, CA (US)

(73) Assignee: CA, INC., New York, NY (US)

(21) Appl. No.: 14/643,029

(22) Filed: Mar. 10, 2015

(51) Int. Cl. G06F 9/44; G06F 17/27; G06F 17/22

(52) U.S. Cl. CPC G06F 8/38; G06F 17/2247; G06F 17/2765

(57) ABSTRACT

A system for creating a wireframe from a user interface of a software application is proposed. The software application is run on a computing system such that the user interface is displayed on a monitor. A portion of the user interface is blocked from view. An image of the user interface, with the portion being blocked from view, is captured and used to automatically create code describing the user interface. For example, one or more shapes in the image are recognized as user interface widgets and HTML code (or other type of code) is created that describes the recognized widgets.

### BACKGROUND

A wireframe, also known as a website wireframe, is a visual guide that represents the skeletal framework of a website or web based service. Wireframes are created for the purpose of arranging elements to best accomplish a particular purpose. The purpose is usually being informed by a business objective and a creative idea. The wireframe depicts the page layout or arrangement of the website's content, including interface elements and navigational systems, and how they work together. The wireframe usually lacks content, typographic style, color, or graphics, since the main focus lies in functionality, behavior, and priority, rather than on content. Wireframes help establish functionality, and the relationships between different screen elements of a website. Aside from websites, wireframes are utilized for the prototyping of mobile sites, computer applications, or other screen-based products that involve human-computer interaction, such as Software as a Service (SaaS).

SaaS is a software distribution model in which applications are hosted by a vendor or service provider and made available to customers over a network, typically the Internet. Porting legacy application to a SaaS environment typically requires re-implementation of the graphic user interface (UI)) using HTML. HTML design often requires creation of a wireframe from scratch, which is a labor intensive and error-prone process.

### BRIEF SUMMARY

A system for creating a wireframe from a user interface of a legacy software application is proposed. This wireframe can be used to port the software application to a SaaS environment. The wireframe is created by running the legacy software application on a computing system such that the user interface is displayed on a monitor. A portion of the user interface (e.g., content) is blocked from view. An image of the user interface, with the portion being blocked from view, is captured and used to automatically create code describing the user interface. For example, one or more shapes in the image are recognized as user interface widgets and HTML code (or other types of code) is created that describes the recognized widgets.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a block diagram depicting the components of one embodiment of a system that can create a wireframe using the technology described herein.

FIG. 2 is a block diagram depicting the software on an example computer.

FIG. 3 is a block diagram depicting the software on an example computer.

FIG. 4 depicts an example user interface (UI).

FIG. 5 depicts an example e-ink display used to block a portion of a UI.

FIG. 6 depicts an example e-ink display blocking a portion of a UI.

FIG. 7 is a flow chart describing one embodiment of a process for building a wireframe from a UI of a legacy software application

FIG. 8 is a flow chart describing one embodiment of a creating a wireframe from an image.

FIG. 9 is a block diagram depicting the software on an example computer.

FIG. 10 is a flow chart describing one embodiment of a process for building a wireframe from a UI of a legacy software application.

FIG. 11 is a block diagram of the components of an example computer system.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon for programming a computer/processor.

Any combination of one or more computer readable media may be utilized. The computer readable media may be a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Pert, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, processor other programmable data processing apparatus, or other devices to function in a particular manner, such that the instructions when stored in the computer readable medium produce an article of manufacture including instructions which when executed, cause a computer or processor to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

A system for creating a wireframe from a user interface of a software application is proposed herein. The wireframe is created by running software application on a computing system such that the user interface is displayed on a monitor. A portion of the user interface is blocked from view. An image of the user interface, with the portion being blocked from view, is captured and used to automatically create code describing the user interface. For example, one or more shapes in the image are recognized as user interface widgets and HTML code (or other types of code) is created that describes the recognized widgets.

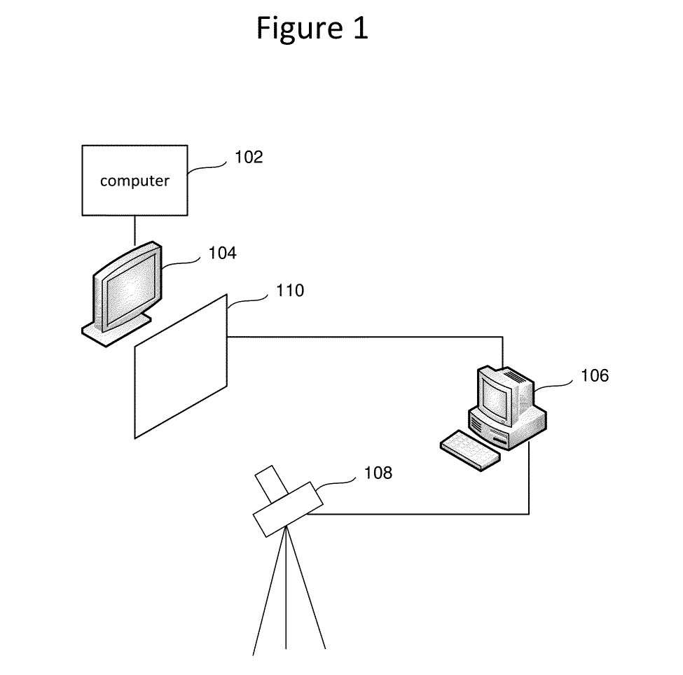

FIG. 1 is a block diagram depicting the components of one embodiment of a system that can create a wireframe using the technology described herein.

FIG. 1 shows computer 102 connected to monitor 104. Computer 102 can be a personal computer, laptop computer, mainframe computer, workstation, tablet, mobile computing device, etc. Monitor 104 can be a flat panel display, CRT, or projector/screen. FIG. 1 also shows computer 106 connected to e-ink display 110 and camera 108. Although FIG. 1 shows the connection as being wired, the connections could also be wireless. In addition, in some embodiments, computer 102 can be in communication with computer 106 via a wired LAN, wireless LAN, the Internet, a WAN, or other communication technology.

E-ink display 110 is a transparent electrochromic display that includes materials that change/add color (e.g., black or other color) when electricity is applied. While some displays can be used to show black and white, others are operated such that (based on the applied electricity) one or more portions of the e-ink display are black (or dark or have other color) or otherwise opaque, and one or more other portions of the display are transparent. The e-ink display can be implemented using traditional e-ink technologies, as well as transparent LEDs or OLEDs, as well as other technologies known in the art. In one embodiment, computer 106 includes software for configuring e-ink display 110. In one example embodiment, the software configuring e-ink display 110 can black out the entire display and then add shapes of transparent regions, with the shapes being of various sizes and can be placed in any location on the e-ink display 110.

Camera 108, which can be a digital still camera or a digital video camera. Computer 106 can be used to trigger the shutter of camera 108 to take a photograph or a video. Images or video captured by camera 108 can be transmitted to computer 106. In another embodiment, camera 108 includes a wireless trigger such that computer 106 can trigger the shutter via a wireless signal. In another embodiment, e-ink display 110 can include a light trigger which when flashed will be sensed by a sensor on camera 108 in order to trigger camera 108 to take a photograph or video.

Camera 108 is placed in front of monitor 104 and pointed at monitor 104 so that camera 108 can take photos (or video) of whatever is being displayed by monitor 104. In the embodiment when it is desired to create a wireframe for the user interface (UI) of a legacy software application, the legacy software application will be run on computer 102 with the UI being displayed on monitor 104. Camera 108 is positioned and pointed such that camera 108 can take photos (capture images) of the user interface on monitor 104. E-ink display 110 is positioned between monitor 104 and camera 108 so that e-ink display 110 can be configured to selectively block portions of the user interface being displayed on monitor 104. Camera 108 views the UI on monitor 104 through e-ink display 110. As discussed above, the goal in creating the wireframe is to be able to describe the functionality of the UI. It is not necessary that all the content be added to the wireframe too. Therefore, an operator (e.g., human operator) can work with computer 106 to configure e-ink display 110 to block from view some or all content of the UI being displayed on monitor 104, as well as block various UI elements if desired. In one embodiment, e-ink display 110 is configured to block content and not block widgets of the UI. A widget is a UI element that a computer user interacts with through direct manipulation. Examples of UI elements include (but are not limited to) windows (may display still images or videos), dropdown menus, tabs, textboxes, buttons, dials, sliders, dialogue boxes, text insertion points, adjustment handles, icons, etc. No particular set of widgets is required for the technology described herein.

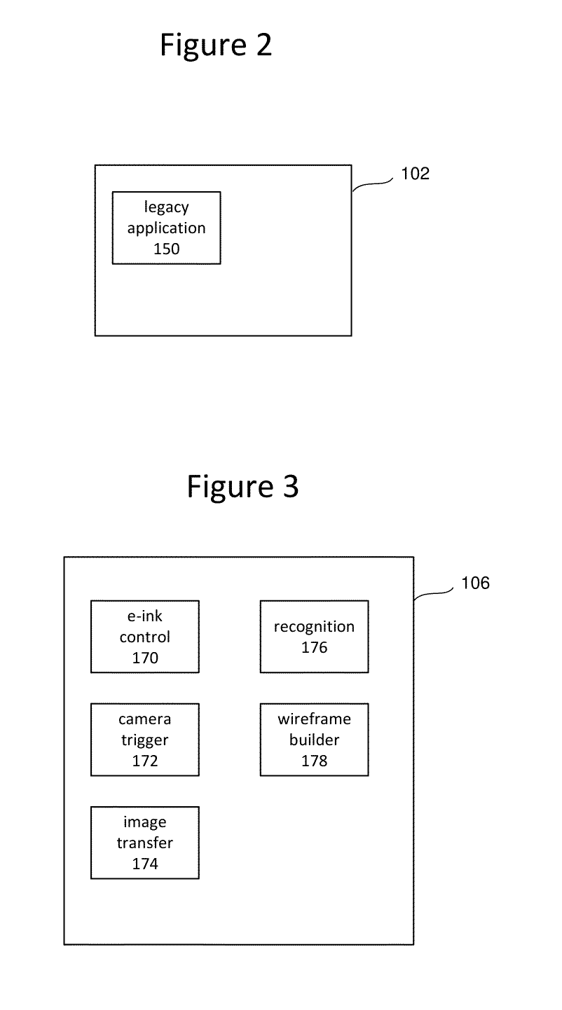

FIG. 2 is a block diagram depicting one example of software resident on computer 102. For example, computer 102 can store and execute the legacy software application 150, which may be in the process of being ported to a SaaS environment. The technology described herein can be used to create a wireframe of the UI of legacy software application 150. Therefore, legacy software application 150 will be executed by computer 102 such that its user interface is displayed on monitor 104. Computer 102 may include a mouse, touchpad, light pen, microphone, camera, etc. for interacting with the user interface. In one embodiment, monitor 104 includes a touchscreen display.

FIG. 3 is a block diagram describing one embodiment of software loaded on computer 106. For example, computer 106 may include e-ink control software 170, camera trigger software 172, image transfer 174, recognition software 176, and wireframe builder 178. In one embodiment, e-ink control software 170 is used to determine which portions of e-ink display 110 are opaque and which portions of e-ink display 110 are transparent. For example, e-ink control software 170 can be used to choose locations for transparency and the shapes of the transparencies. Users can add squares, triangles, rectangles, circles, etc. in different portions of the display in order to make those portions transparent, with the remainder of the display being opaque. In other embodiments, the opposite can be done where the e-ink display starts out transparent and the user adds opaque areas. The user can use e-ink control software 170 to choose the position and size of various shapes of transparency.

Camera trigger software 172 is used to trigger the shutter of camera 108. In one embodiment, there is a wired connection between computer 106 and camera 108 to control the shutter. In other embodiments, an RF wireless connection could be used. In yet other embodiments, a light can be used to trigger camera 108. In one example, a light on e-ink display 110 can be used to trigger camera 108, with that light being controlled (via a wired or wireless connection) by computer 106 and camera trigger software 172. In one embodiment, a user will use a user interface to engage camera trigger software 172 to control camera 108.

Image transfer software 174 is used to transfer images from camera 108 to computer 106. In one embodiment, images are transferred via a wired connection. In another embodiment, images are transferred via a wireless connection. The images captured and transferred by camera 108 can include jpg format, camera raw format, or any other format known by those of ordinary skill in the art.

Recognition software 176 is used to recognize user interface elements (e.g., widgets) in the UI displayed on monitor 104 and not blocked by e-ink display 110. The user interface elements are recognized in the photographs (images) captured by camera 108. In one embodiment, recognition software 176 will recognize shapes and identify the locations of those shapes in the UI. In one embodiment, the operator will train recognition software 176 to recognize various user interface elements. There are various technologies well known in the art for training software to recognize shapes, and no particular recognition technology is required for this implementation.

Wireframe builder 178 will use the recognition of shapes and the locations of those shapes in order to create the code for an HTML file (or portions of an HTML file) that will comprise the wireframe. In other embodiments, other programming languages, different than HTML, can also be used. While wireframe builder 178 will create the code that represents the recognized user interface elements, that code will then be provided to a wireframe editor (not depicted) to be further edited by a user as part of a design process for the porting of a legacy application to a SaaS environment.

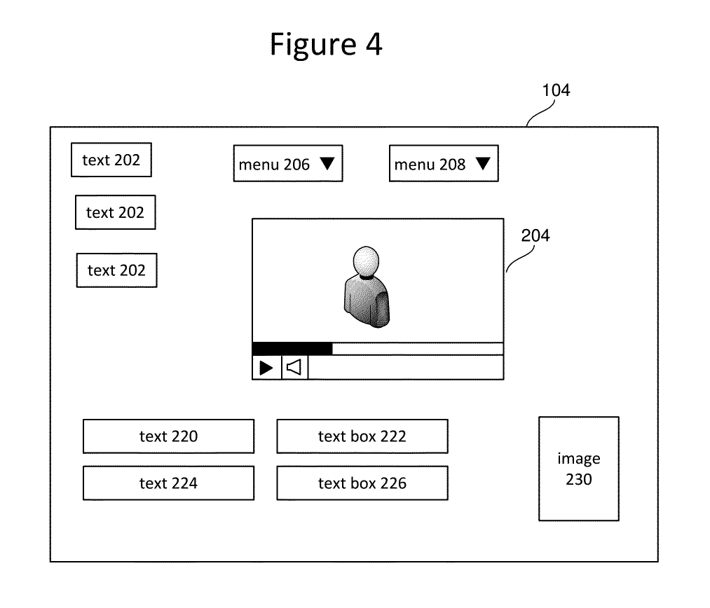

FIG. 4 provides one example of a user interface for legacy application 150 that is being depicted on monitor 104. This particular example of a user interface includes three portions of text 202, which may be instructions, information, etc. The user interface of FIG. 4 also includes a window 204 for showing a video of a person talking. The user interface also includes dropdown menu 206 and dropdown menu 208. By clicking on the upside-down triangles, the dropdown menus will open up and show the various options for the user to select. In one embodiment, the operator can take an image of the user interface with the dropdown menus closed and images of the user interface with the dropdown menus open. The user interface of FIG. 4 also includes text 220, requesting information to be input into an accompanying textbox 222. The user interface also includes text 224, requesting information to be input into an accompanying textbox 226. The user interface also includes an image 230 which can be informational, a company logo, a trademark, advertising, etc. Text 202 and image 230 are examples of content. Window 204, menu 206, menu 208, textbox 222 and textbox 226 are examples of widgets. In one embodiment, widgets are ported to the SAS environment via the wire, while content is not. When porting to a SaaS environment, the operator may choose to port or not port image 230 or text 202. That decision will affect which portions of e-ink display 110 will be blocking and which will not be blocking.

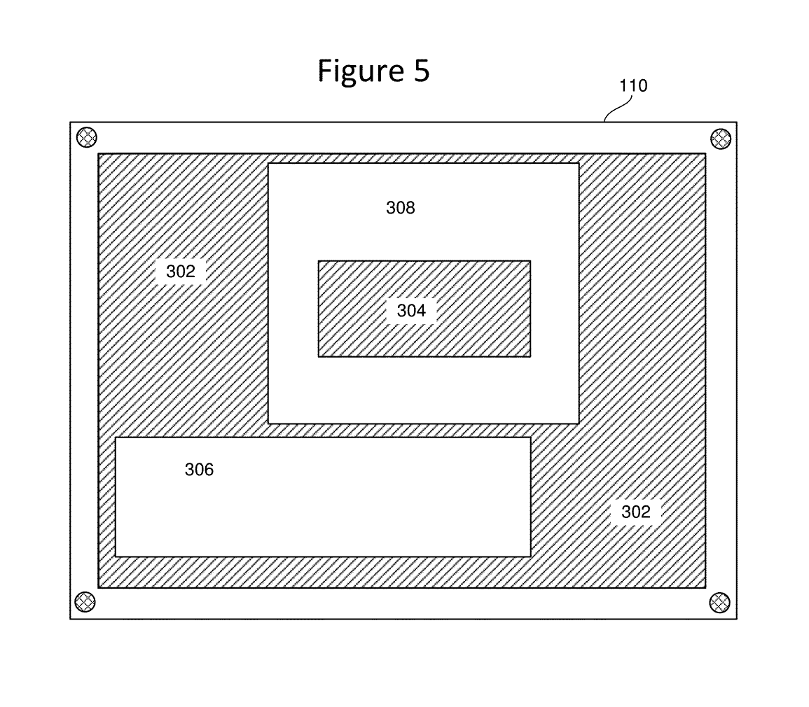

FIG. 5 shows an example of e-ink display 110 having portions 302 that are opaque and, therefore, blocking view of what is behind e-ink display 110. Also depicted are portion 306 and portion 308, which are transparent and allow camera 108 to view behind e-ink display 110 at monitor 104. Within region 308 is a sub-region 304 which is also opaque and blocking the view of camera 108.

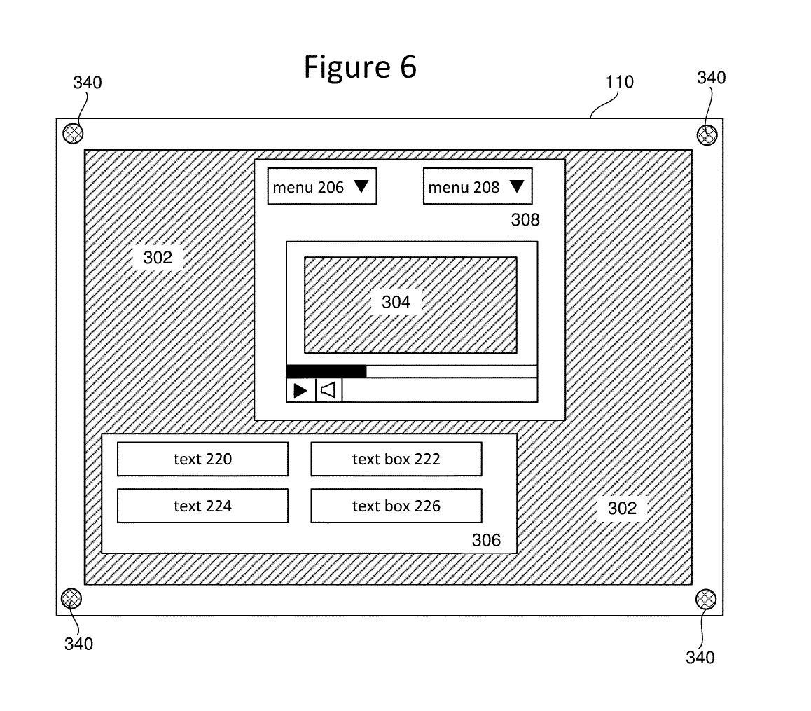

FIG. 6 shows e-ink display 110 with portions 302 and 304 being opaque, and portions 306 and 308 being transparent, just as in FIG. 5. However, FIG. 6 shows the view through transparent portions 306 and 308 of the user interface being displayed on monitor 104. That is, FIG. 6 displays what would be viewed by camera 108 when looking through e-ink display 110 at the UI being displayed on monitor 104. As can be seen, text 220, textbox 222, text 224 and textbox 226 are visible in transparent region 306. Menu 206, menu 208 and window 204 are viewable by camera 108 through transparent region 308. However, the content of the video being displayed in window 204 is being blocked by opaque region 304. Note that the opaque regions can be black, gray or other color.

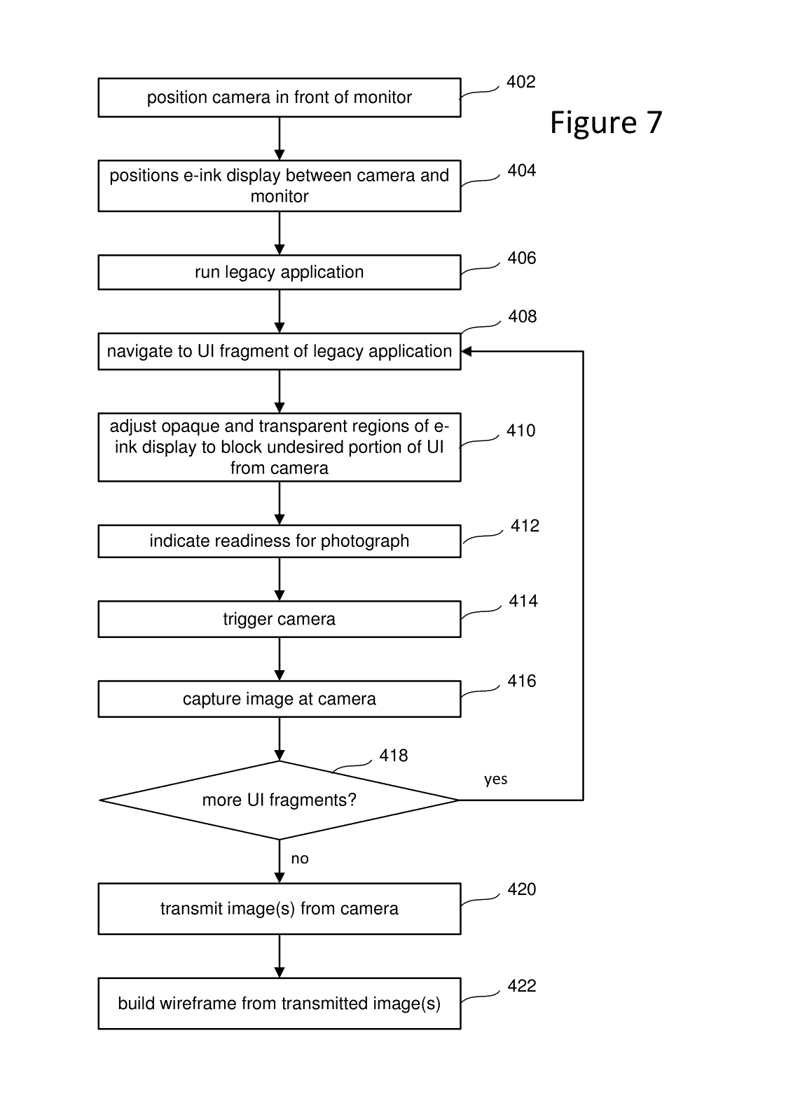

FIG. 7 is a flowchart describing one embodiment for creating the wireframe using the components of FIG. 1 (or similar components). In step 402, an operator will position the camera 108 in front of monitor 104 so that camera 108 is pointed at and views monitor 104. In this manner, the camera can take photographs of the UI being displayed on monitor 104. In step 404, the operator positions the e-ink display between camera 108 and monitor 104. In one embodiment, e-ink display 110 can be mounted directly on monitor 104 or in front of monitor 104. In step 406, the legacy software application is run on computer 102. In step 408, an operator will navigate the legacy software application to the UI fragment desired to be used to create a wireframe. In some embodiments, multiple fragments can be used to create a single wireframe or multiple fragments can be used to create multiple wireframes. In step 410, the operator will adjust the opaque and transparent regions of e-ink display 110 in order to block undesired portions of the UI from camera 108. For example, the operator will use software 170 of computer 162 to configure e-ink display 110 to be displaying opaque and transparency regions as depicted in FIGS. 5 and 6.

In Step 412, the operator indicates that a photograph (or video) should be taken. The operator can do this by manipulating a user interface on computer 106 or using some type of remote control for computer 106 or camera 108. As discussed above, computer 106 can trigger the shutter of computer 108 using a wired or wireless connection. Additionally, e-ink display 110 can include a set of trigger lights 340 (FIG. 6), controlled by computer 106, which causes the shutter of camera 108 to take a photo (or video) in response to flashing of the lights 340. In response to the indication that a photograph should be taken, the camera will be appropriately triggered in step 414 and an image will be captured by camera 108 in step 416. As described above, the image captured in step 416 is the image of the UI being displayed on monitor 104 looking through e-ink display 110 (which has portions that are transparent and portions that are opaque). Thus, some of the UI will be blocked. If there are more UI fragments to capture (step 418) then the process loops back to step 408. If there are no more UI fragments to capture, then (at step 420) the one or more photographs taken by camera 108 are transmitted to computer 106. In step 422, computer 106 will build a wireframe from the one or more transmitted photographs.

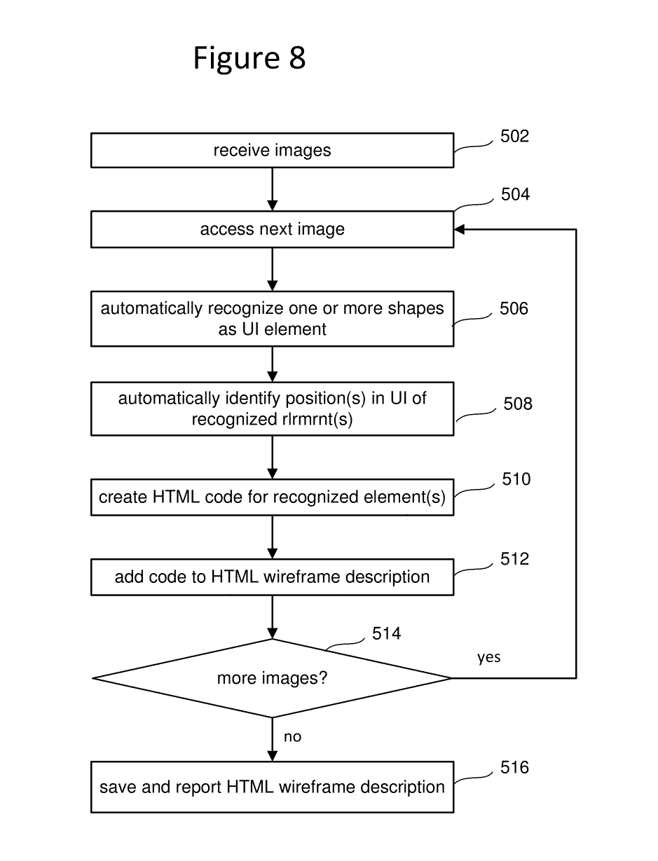

FIG. 8 is a flowchart describing the process for building the wireframe from the transmitted photographs, and represents more details of step 422 of FIG. 7. In step 502 of FIG. 8, computer 106 receives the images from camera 108. In step 504, the next image is access for processing. If there was only one image received in step 502, then that one image is what is accessed in step 504. Alternatively, if many images are received in step 502, one of those images is accessed in each iteration of step 504. In step 506, computer 106 automatically recognizes one or more shapes in the image as UI items. In step 508, computer 106 identifies the position of the recognized shapes. In step 510, computer 106 creates HTML code that defines the recognized user interface element. The HTML code will describe location, shape and type of user interface element. That code is added to the HTML wireframe description in step 512. Note that in other embodiments, other types of code (other than HTML) can also be used/created. In step 514 it is determined whether there are more images. If there are more images to process, then the method of FIG. 8 loops back to step 504, accesses the next image and processes that image in steps 506-512. If there are no more images to process (step 514), then the HTML wireframe description is saved in an HTML (or other type of) file and that file, representing the wireframe description, is reported to the operator. For example, an e-mail, text message, dialogue box, etc. can be sent/displayed in response to saving the file to indicate that the process has completed. In one embodiment, the process of FIG. 8 is an automatic process performed by computer 106.

Looking back at FIG. 7, in one embodiment, steps 406 and 408 are performed by computer 104 while steps 410, 414 and 422 are performed by computer 106. Another embodiment only utilizes one computer which will run legacy software application 150, e-ink control 170, camera trigger 172, image transfer software 174, recognition software 176 and wireframe builder 178 such that that one computer will perform steps 406, 408, 410, 414 and 422. In some embodiments, an operator will perform steps 402, 404 and step 412.

In another embodiment, there will only be one computer and no external camera. This one computer will run the legacy software application, perform the image capture, perform the blocking and perform the shape recognition in order to create the wireframe. For example, this embodiment only includes computer 102 and monitor 104 (no camera and no computer 106).

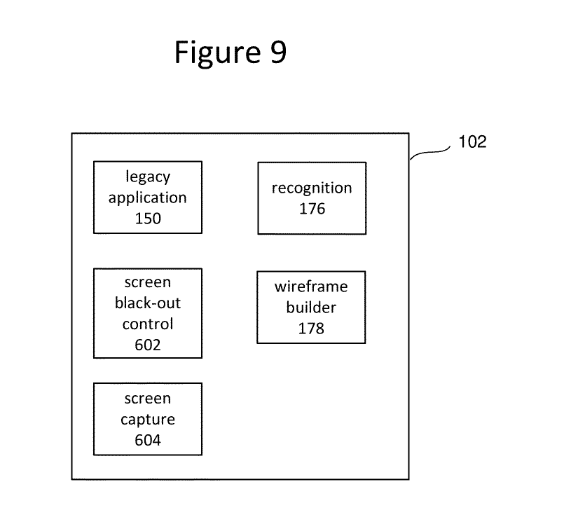

FIG. 9 is a block diagram of an alternative embodiment for computer 102 that includes legacy software application 150, screen black-out controller software 602, screen capture 604, recognition software 176 and wireframe builder 178. Legacy software application 150, recognition software 176 and wireframe builder 178 work as discussed above. Screen black-out control software 602 is used to black out portions of monitor 104. The user can specify shapes and locations for those shapes to black out portions of monitor 104. Screen capture 604 creates a screen capture of monitor 104 that includes the blacked-out shapes. Therefore, when displaying a user interface in legacy application 150, the operator can use screen black-out control software 602 to black out portions of the user interface and then take a screen capture with screen capture software 604 to capture the user interface that is partially blacked out. That screen capture can be saved as a JPEG or other file format appropriate for photographs, and provided to recognition software 176. Recognition software 176 and wireframe builder 178 will perform the process of FIG. 8, as described above.

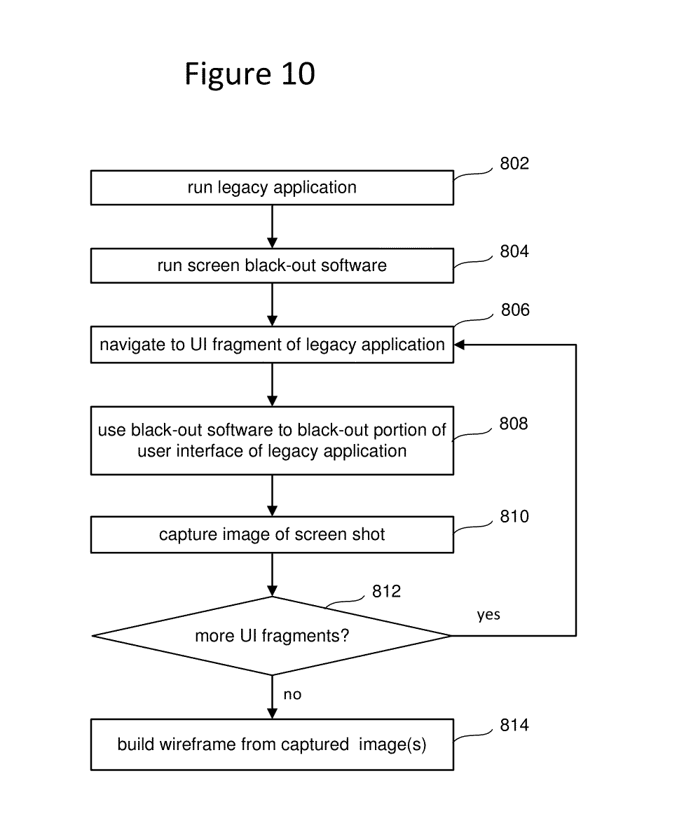

FIG. 10 is a flowchart describing the operation of computer 102 according to the embodiment of FIG. 9. Computer 102 runs legacy software application in step 802. In step 804, the black-out software 602 will be used to black out portions of the user interface, similar to as described above with respect to FIG. 6. In step 806, the operator will navigate to the appropriate UI fragment of the legacy software application. In step 808, the black-out software will be used by the operator to black out portions of the user interface of the legacy application. In step 810, the system will create a screenshot of the user interface being displayed on monitor 104, including the blacked out portions. If there are more UI fragments to capture images of, (step 810), then the process will loop back to step 806. If there are no more UI fragments to capture (step 812), then in step 814, recognition software 176 and wireframe builder 178 will be used to build the wireframe from the captured images in step 814. The output of step 814 can include one or more HTML files. In other embodiments, different types of code can be used to create the wireframe and, therefore, the output will be different types of files or structures.

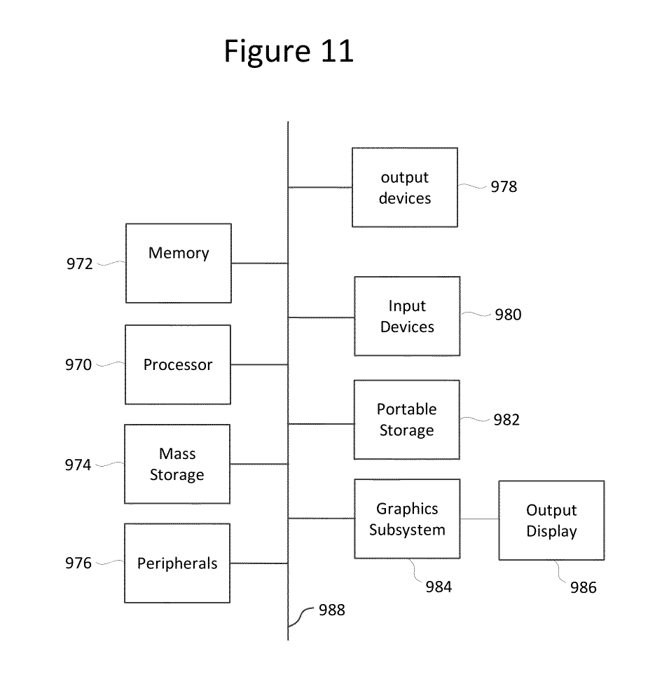

FIG. 11 illustrates a high level block diagram of a computer system which can be used to implement computer 102 (see FIG. 1) and/or computer 106 (see FIG. 1). The computer system of FIG. 11 includes a processor unit 970 in communication with main memory 972. Processor unit 970 may contain a single microprocessor, or may contain a plurality of microprocessors for configuring the computer system as a multi processor system. These one or more processors can perform the processes described above. Main memory 972 stores, in part, instructions and data for execution by processor unit 970. If the system described herein is wholly or partially implemented in software, main memory 972 can store the executable code when in operation. Main memory 972 may include banks of dynamic random access memory (DRAM) or flash memory, as well as high speed cache memory.

The system of FIG. 11 further includes a mass storage device 974, peripheral device(s) 976, user input device(s) 980, output devices 978, portable storage medium drive(s) 982, a graphics subsystem 984 and an output display 986. For purposes of simplicity, the components shown in FIG. 11 are depicted as being connected via a single bus 988. However, the components may be connected through one or more data transport means. For example, processor unit 970 and main memory 972 may be connected via a local microprocessor bus, and the mass storage device 974, peripheral device(s) 976, portable storage medium drive(s) 982, and graphics subsystem 984 may be connected via one or more input/output (I/O) buses. Mass storage device 974, which may be implemented with a magnetic disk drive or an optical disk drive, is a non-volatile storage device for storing data and instructions for use by processor unit 970. In one embodiment, mass storage device 970 stores the system software for implementing the technology described herein for purposes of loading to main memory 572. Peripheral device(s) 976 may include any type of computer support device, such as an input/output (I/O) interface, to add additional functionality to the computer system. For example, peripheral device(s) 976 may include a network interface for connecting the computer system to a network, a modem, a router, etc. User input device(s) 980 provides a portion of a user interface User input device(s) 980 may include an alpha-numeric keypad for inputting alpha-numeric and other information, or a pointing device, such as a mouse, a trackball, stylus, or cursor direction keys. In order to display textual and graphical information, the computer system of FIG. 11 includes graphics subsystem 984 and output display 986. Output display 986 may include a cathode ray tube (CRT) display, liquid crystal display (LCD), head mounter display, projector or other suitable display device. Graphics subsystem 984 receives textual and graphical information, and processes the information for output to display 986. Additionally, the system of FIG. 11 includes output devices 978. Examples of suitable output devices include speakers, printers, network interfaces, monitors, etc.

The components contained in the computer system of FIG. 11 are those typically found in computer systems suitable for use with the technology described herein, and are intended to represent a broad category of such computer components that are well known in the art. Thus, the computer system of FIG. 11 can be a personal computer, mobile computing device, smart phone, tablet, workstation, server, minicomputer, mainframe computer, or any other computing device. The computer can also include different bus configurations, networked platforms, multi-processor platforms, etc. Various operating systems can be used

One embodiment of the technology described herein includes a method of creating a wireframe for a user interface of a software application, comprising: blocking a portion of the user interface from view; capturing an image of the user interface with the portion being blocked from view; and automatically creating code describing the user interface from the captured image of the user interface with the portion being blocked from view.

One embodiment includes a system for creating a wireframe for a user interface of a software application, comprising: a computing system including a monitor, the computing system runs the software application and displays the user interface on the monitor; a camera pointed at the monitor; and an e-ink display positioned between the monitor and the camera such that the camera views the user interface on the monitor through the e-ink display, the e-ink display is configurable to selectively block a portion of the user interface from view by the camera, the camera is triggerable to capture an image of the user interface with the portion being blocked from its view and transmit the image to the computing system, the computing system is configured to automatically create an HTML description of the user interface from the captured image.

One embodiment includes a computer program product, comprising: a computer readable storage medium having computer readable program code embodied therewith, the computer readable program code comprising: computer readable program code configured to receive an image of a user interface of a software application with a portion of the user interface being blocked from view; and computer readable program code configured to automatically create code describing the user interface from the received image of the user interface of the software application with the portion of the user interface being blocked from view.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of creating a wireframe for a user interface of a software application, comprising:
blocking a portion of the user interface from view;
capturing an image of the user interface with the portion being blocked from view; and
automatically creating code describing the user interface from the captured image of the user interface with the portion being blocked from view.

2. The method of claim 1, wherein:
the automatically creating code comprises automatically creating an HTML description of the user interface from the captured image showing the portion being blocked from view.

3. The method of claim 1, wherein:
the capturing an image is performed by a camera; and
the automatically creating code is performed by a computer.

4. The method of claim 1, wherein:
the automatically creating code comprises automatically recognizing a shape in the captured image and creating code that describes a user interface element corresponding to the recognized shape.

5. The method of claim 4, wherein:
the automatically creating code further comprises automatically identifying a position of the shape in the user interface, the created code describes that position.

6. The method of claim 1, wherein:
the blocking is performed by configuring an e-ink display.

7. The method of claim 1, wherein:
the blocking is performed by using back-out software to black-out the portion on a computer screen.

8. The method of claim 1, further comprising:
running the software application on a first computer, including displaying the user interface from a monitor of the first computer;
wherein the automatically creating code is performed by a second computer, the capturing an image is performed by a camera connected to the second computer, and the blocking is performed by configuring an e-ink display that positioned between the camera and the monitor.

9. The method of claim 8, wherein:
the e-ink display is configured by the second computer; and
the camera is triggered by the second computer.

10. The method of claim 9, wherein:
the automatically creating code comprises automatically recognizing a shape in the captured image and creating an HTML description of that shape from the captured image showing the portion of the user interface being blocked from view.

11. The method of claim 8, wherein:
the camera is triggered by the e-ink display.

12. A system for creating a wireframe for a user interface of a software application, comprising:
a computing system including a monitor, the computing system runs the software application and displays the user interface on the monitor;
a camera pointed at the monitor; and
an e-ink display positioned between the monitor and the camera such that the camera views the user interface on the monitor through the e-ink display, the e-ink display is configurable to selectively block a portion of the user interface from view by the camera, the camera is triggerable to capture an image of the user interface with the portion being blocked from its view and transmit the image to the computing system, the computing system is configured to automatically create an HTML description of the user interface from the captured image.

13. The system of claim 12, wherein:
the computing system includes a first computer and a second computer;
the first computer is connected to the monitor and is configured to run the software application; and
the second computer is configured to trigger the camera, receive the captured image from the camera, configure the e-ink display and create the HTML description of the user interface from the captured image.

14. The system of claim 12, wherein:
the e-ink display is configurable to have a first region that is transparent and a second region that is opaque, the region that is opaque blocks the portion of the user interface from view by the camera.

15. The system of claim 12, wherein:
the computing system is configured to automatically create the HTML description of the user interface from the captured image by recognizing a shape in the captured image and creating HTML code describing a user interface element corresponding to the recognized shape.

16. A computer program product, comprising:
a computer readable storage medium having computer readable program code embodied therewith, the computer readable program code comprising:
computer readable program code configured to receive an image of a user interface of a software application with a portion of the user interface being blocked from view; and
computer readable program code configured to automatically create code describing the user interface from the received image of the user interface of the software application with the portion of the user interface being blocked from view.

17. The computer program product of claim 16, further comprising:
computer readable program code configured to run the software application including displaying the user interface from a monitor.

18. The computer program product of claim 16, wherein:
the computer readable program code configured to automatically create code describing the user interface automatically creates an HTML description of the user interface from the captured image showing the portion of the user interface being blocked from view.

19. The computer program product of claim 16, wherein:
the computer readable program code configured to automatically create code describing the user interface automatically recognizes a shape in the captured image and creates HTML code that describes a user interface element corresponding to the recognized shape.

20. The computer program product of claim 16, wherein:
the computer readable program code configured to automatically create code describing the user interface automatically recognizes a shape in the captured image, identifies a position of the shape in the user interface and creates HTML code that describes a user interface element corresponding to the recognized shape and identified position.
